(19) United States
(12) Patent Application Publication
(10) Pub. No.: US 2010/0121772 A1
(43) Pub. Date: May 13, 2010

(54) System and method for transforming generically formatted person data specifically formatted postmortem reports

(76) Inventor: Yvonne Fitzpatrick, Streamwood, IL (US)

Correspondence Address: The John Marshall Law School;Center for Intellectual Property Law-Patent Clinic, 315 S. Plymouth Court, Chicago, IL, 60604, US

(21) Appl. No.: 12/456,416

(22) Filed: Jun. 16, 2009

Related U.S. Application Data
(63) Continuation-in-part of application No. 11/306,328, filed on Dec. 22, 2005, now abandoned.
Application No. 11/306,328 is a continuation-in-part of application No. 09/774,807, filed on Feb. 1, 2001.

(51) Int. Cl. G06Q 10/00; G06Q 50/00; G06F 17/30

(52) U.S. Cl. 705/342; 707/756; 707/E17.005

(57) ABSTRACT

When triggered by a death-reporting trigger agent, reporting that a person is now a deceased person, the system transforms generically formatted person data representing physical characteristics of the person to specifically formatted postmortem reports for report-receiving agents, where at least a funeral director is a trigger agent and at least a public health agency is a report-receiving agent.

This application is a continuation in part of co-pending U.S. Patent application Ser. No. 11/306,328 filed 22 Dec. 2005 which is incorporated herein by reference and which is a continuation in part of U.S. application Ser. No. 09/774,807 filed 1 Feb. 2001 which is incorporated herein by reference.

The system comprises an information system, instructions for the information system, and inputs to the information system. The instructions, when triggered by death-reporting stored trigger data, use stored format data to cause the information system to transform generically formatted stored person data into specifically formatted postmortem reports.

The system operates the method.

The system and method avoid the long-troubling problem of needing to enter data in many specific formats with errors, inconstancies, and incompleteness likely. The system and method achieve the long-sought goals of providing—for example for a funeral director—means for generating many specifically postmortem reports with one triggering entry and providing report-receiving agents—such as public health agencies—more complete and more reliable data.

The figure shows the system schematically:

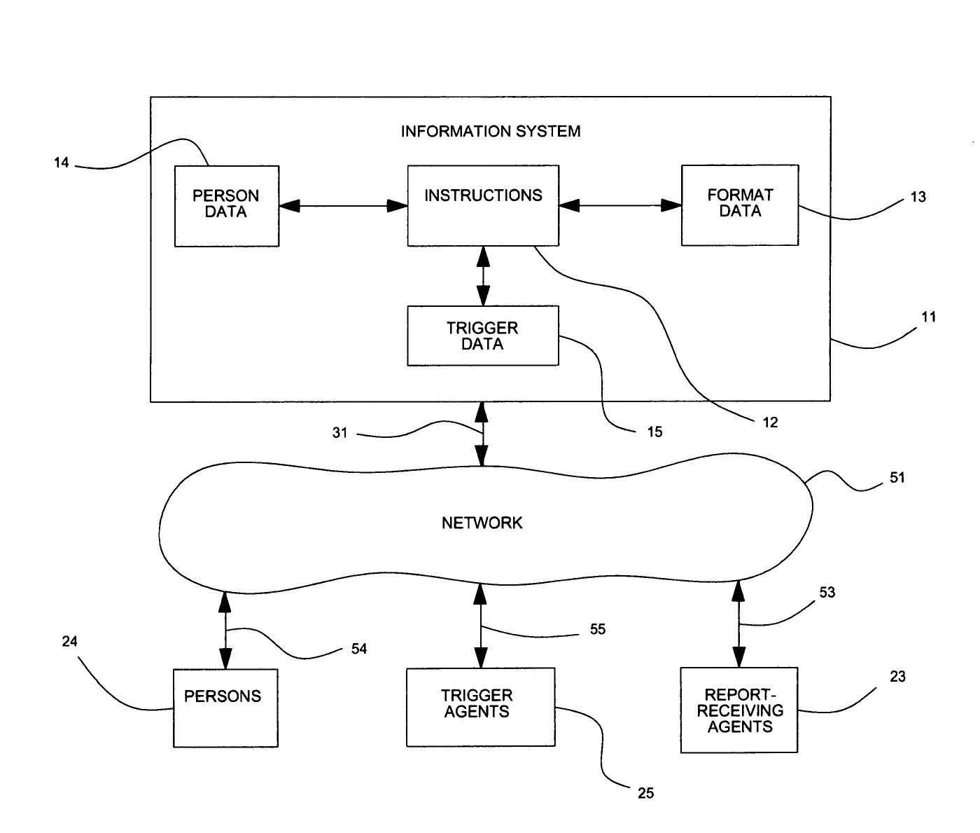

In the FIG. 11 indicates an information system and 12 indicates instructions which cause the information system to transform generically formatted data to specifically formatted postmortem reports.

Stored format data 13 are input from report-receiving agents 23 and can be input 53, 31 via a network 51. Stored person data 14 are input from persons 24 and can be input 54, 31 via the network 51. Stored trigger data 15 are input by trigger agents 25 and can be input 55, 31 via the network 51.

“Input from” includes input by a representative. For example, a trigger agent can be this representative for person data.

Person data represent physical characteristics of persons. Trigger agents comprise at least a funeral director. Report-receiving agents comprise at least a public health agency.

Format data from a report-receiving agent can be accessed from and updated from that report-receiving agent. That report-receiving agent can request changes in person data. Trigger data from a trigger agent can be accessed from and updated from that trigger agent. Person data input from a person can be accessed and updated from that person.

Format data from a report receiving agent comprise a rule specifying which parts of person data for a deceased person are parts of a postmortem report desired by the report-receiving agent. The rule can also specify the order of the data in the postmortem report.

When a component of trigger data is death-reporting data specifying that a person is deceased, then this triggers the instructions to use rules in format data to transform person data to postmortem reports for report-receiving agents.

The system for transforming generically formatted data to specifically formatted postmortem reports comprises, an information system, instructions for the information system, and inputs to the information system.

When triggered by death-reporting stored trigger data, the instructions use stored format data to cause the information system to transform generically formatted stored person data into specifically formatted postmortem reports. The instructions are encoded in an information bearing medium readable by the information system. The information system has data input capacity, data output capacity, data storage capacity, and data processing capacity.

The stored format data comprise at least first stored format data. The first stored format data comprise at least a first format rule specifying which parts of the stored first person data are used for a first postmortem report. The first stored format data are input to, and stored, in the information system from at least a first report-receiving agent.

The first stored format data can be accessed from and updated from the first report-receiving agent. The first report receiving agent can request additions to stored person data.

The first report-receiving agent is any report-receiving member of a report plurality of report-receiving agents. At least a public health agency is a report-receiving member of the report-receiving plurality.

Stored person data comprise at least first stored person data representing physical characteristics of a first person. The first stored person data are input to, and stored in, the information system from at least the first person. The first stored person data from the first person can be accessed from and updated from the first person. The first person is any person member of a person plurality of persons.

Stored trigger data comprise at least first stored trigger data input to, and stored in, the information system from at least a first trigger agent. The first stored trigger data from the first trigger agent can be accessed from and updated from the first trigger agent. The first trigger agent is a trigger member of a trigger plurality of trigger agents. At least a funeral director is a trigger member of the trigger plurality of trigger agents.

When the first stored trigger data is death-reporting data designating that the first person is a deceased person, then the instructions are triggered to cause the information system to use at least the first stored format data to transform the stored person data into at least a first specifically formatted first postmortem report

The System operates a method for transforming generically formatted data to output specifically formatted postmortem reports. The method comprises 1) providing instructions for an information system, 2) inputting to, and storing in, the information system first stored person data from at least a first person, 3) inputting to, and storing in, the information system first stored format data from at least a first report-receiving agent, 4) inputting to, and storing in, the information system first stored trigger data from at least a first trigger agent, and 5) transforming first stored person data to at least a first postmortem report for the first report-receiving agent when the first stored trigger data comprises first death-reporting trigger data designating that the first person is a deceased person triggers the instructions to cause the information system to use at least the first stored format data to transform the first stored person data into at least a first specifically formatted first postmortem report.

The instructions are encoded in an information bearing medium readable by the information system. The information system has data input capacity, data output capacity, data storage capacity, and data processing capacity.

First stored person data represent physical characteristics of the first person. The first stored person data from the first person can be accessed from and updated from the first person. The first person is any person member of a person plurality of persons and first stored person data are parts of stored person data.

The first stored format data comprise at least a first format rule specifying which members of the first stored person data are used for the first postmortem report.

The first stored format data can be accessed from and updated from the first report-receiving agent. The first report-receiving agent can request additions to the stored person data.

The first report-receiving agent is an_{y} report-receiving member of a report plurality of report-receiving agents and the first stored format data are parts of stored format data. At least a public health agency is a report-receiving member of the report-receiving plurality.

First stored trigger data can be accessed from and updated from the first trigger agent.

The first trigger agent is any trigger member of a trigger plurality of trigger agents and first stored trigger data are parts of stored trigger data. At least a funeral director is a trigger member of the trigger plurality of trigger agents.

Claimed is:

1. A system for transforming generically formatted data to specifically formatted postmortem reports, the system comprising:
a) instructions for an information system,
b) where, when triggered by death-reporting stored trigger data, the instructions use stored format data to cause the information system to transform generically formatted stored person data into specifically formatted postmortem reports,
c) where the instructions are encoded in an information bearing medium readable by the information system,
d) where the information system has data input capacity, data output capacity, data storage capacity, and data processing capacity,
e) where the stored format data comprise at least first stored format data,
f) where the first stored format data comprise at least a first format rule and a first format template,
g) where the first stored format data are input to, and stored, in the information system from at least a first report-receiving agent,
h) where the first stored format data can be accessed from and updated from the first report-receiving agent,
i) where the first report receiving agent can request additions to stored person data,
j) where the first report-receiving agent is any report-receiving member of a report plurality of report-receiving agents,
k) where at least a public health agency is a report-receiving member of the report-receiving plurality,
l) where stored person data comprise at least first stored person data representing physical characteristics of a first person,
m) where the first stored person data are input to, and stored in, the information system from at least the first person,
n) where the first stored person data from the first person can be accessed from and updated from the first person,
o) where the first person is any person member of a person plurality of persons;
p) where stored trigger data comprise at least first stored trigger data input to, and stored in, the information system from at least a first trigger agent,
q) where the first stored trigger data from the first trigger agent can be accessed from and updated from the first trigger agent,
r) where the first trigger agent is a trigger member of a trigger plurality of trigger agents,
s) where at least a funeral director is a trigger member of the trigger plurality of trigger agents,
t) where, when the first stored trigger data is death-reporting data designating that the first person is a deceased person, then the instructions are triggered to cause the information system to use at least the first stored format data to transform the stored person data into at least a first specifically formatted first postmortem report
u) where the first rule specifies which members of the first stored person data are used for the first postmortem report and the first template specifies the layout of the first postmortem report.

2. A method for transforming generically formatted data to output specifically formatted postmortem reports, the method comprising:
1) providing instructions for an information system,
a) where the instructions are encoded in an information bearing medium readable by the information system,
b) where the information system has data input capacity, data output capacity, data storage capacity, and data processing capacity;
2) inputting to, and storing in, the information system first stored person data from at least a first person,
a) where first stored person data represent physical characteristics of the first person,
b) where the first stored person data from the first person can be accessed from and updated from the first person,
c) where the first person is any person member of a person plurality of persons and first stored person data are parts of stored person data;
3) inputting to, and storing in, the information system first stored format data from at least a first report-receiving agent,
a) where the first stored format data comprise at least a first format rule specifying which members of the first stored person data are used for the first postmortem report,
b) where the first stored format data can be accessed from and updated from the first report-receiving agent,
c) where the first report-receiving agent is any report-receiving member of a report plurality of report-receiving agents and the first stored format data are parts of stored format data,
d) where at least a public health agency is a report-receiving member of the report-receiving plurality,
e) where the first report-receiving agent can request additions to the stored person data;
4) inputting to, and storing in, the information system first stored trigger data from at least a first trigger agent,
a) where first stored trigger data can be accessed from and updated from the first trigger agent,
b) where the first trigger agent is any trigger member of a trigger plurality of trigger agents and first stored trigger data are parts of stored trigger data,
c) where at least a funeral director is a trigger member of the trigger plurality of trigger agents; and
5) outputting the first postmortem report relating to the first person for at least the first report-receiving agent when the first stored trigger data comprises first death-reporting trigger data designating that the first person is a deceased person triggers the instructions to cause the information system to use at least the first stored format data to transform the first stored person data into at least a first specifically formatted first postmortem report.
